(19) United States
(12) Patent Application Publication
(10) Pub. No.: US 2006/0067583 A1
(43) Pub. Date: Mar. 30, 2006

(54) Image compression apparatus, and image compression program storage medium

(75) Inventor: Mitsuru Mushano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/230,700

(22) Filed: Sep. 21, 2005

(30) Foreign Application Priority Data
Sep. 24, 2004 (JP) 2004-276415
Mar. 31, 2005 (JP) 2005-102885

(51) Int. Cl. G06K 9/36

(52) U.S. Cl. 382/239

(57) ABSTRACT

In an image compression apparatus that compresses an original image consisting of image data after rasterizing, the original image is divided in an area into an edge image and a smooth image. The edge image is subjected to, for example, a reversible compression, and the smooth image is subjected to, for example, a non-reversible compression.

### BACKGROUND OF THE INVENTION

1. Field of the Invention

The present invention relates to an image compression apparatus for compressing an original image consisting of image data after rasterizing, and an image compression program storage medium storing an image compression program, when executed in an information processing apparatus, which causes the information processing apparatus to operate as the image compression apparatus.

2. Description of the Related Art

Hitherto, for the purpose of reduction of storage capacity and reduction of traffic, there is widely adopted a technology of compressing image data.

For example, Japanese Patent Laid Open Gazette TokuKai Hei. 5-328142 discloses a technology of constituting a CLUT (color lookup table) through selection of a representative color from the original image in which a color number is allotted in such a manner that a series of color numbers has color data of closer values, and next a bit map associated with the CLUT is created to determine a difference in the color number between adjacent pixels, and wherein in the event that the difference offers a large value, a color number of the bit map is altered within a range that no deterioration of image quality occurs to bias the difference toward a small value, and a run length encoding is applied to the difference data.

Japanese Patent Laid Open Gazette TokuKai Hei. 10-164620 discloses a technology in which imaging data, which consists of a plurality of data allotted to every color, is encoded through the non-reversible compression, and one of the data is allotted to the transparent color that is reversible, wherein the imaging data is constituted of an immediate value (the initial value in the difference encoding) and a plurality of difference values (the previous value in the difference encoding) subsequent to the immediate value. In the technology, when those values are encoded through the non-reversible compression, the immediate value and the difference value, which are representative of the transparent color, are reversible, and the immediate value representative of the transparent color is established with the intermediate value of the data value for every color, and the difference value representative of the transparent color is established with “0”.

Japanese Patent Laid Open Gazette Tokuhyou 2001-520822 proposes a technology in which the number is encoded by the difference between the predicted number (s (j)) and the real number (s (j)).

Japanese Patent Laid Open Gazette TokuKai Hei. 9-200540 discloses an image compression apparatus in which as to Nth-column of pixel data train, a distribution state of the same pixel data in the sub-scanning direction is detected, while a distribution state of the same pixel data in the main scanning direction is detected, and it is determined in accordance with the detection result as to whether the same pixel data continued in the sub-scanning direction is to be subjected to the compression processing, or the same pixel data continued in the main scanning direction is to be subjected to the compression processing.

Here, there will be introduced a system in which a data compression technology is applied.

FIG. 1 shows an example of a print system in which a data compression technology is applied.

As seen from FIG. 1, the print system comprises a host controller 100, interface equipment 200, and a printer 300. The host controller 100 is connected with the interface equipment 200 through a general-purpose interface cable 150 such as SCSI. The interface equipment 200 is connected with the printer 300 through a dedicated interface cable 250.

The host controller 100 applies a RIP (raster image processing) processing to characters and image data described in various languages and formats, for example, PDF, PS, and TIFF, so that bit map data is generated. The host controller 100 further performs compression processing for the bit map data so as to generate compressed data. The compressed data is transferred from the host controller 100 via the general-purpose interface cable 150 to the interface equipment 200. The interface equipment 200 applies the expansion processing to the compressed data transferred so as to generate bit map data associated with the bit map data involved in the state before the compression processing by the host controller 100. In the event that the compression processing by the host controller 100 is the non-reversible compression processing, the bit map data generated through the expansion processing by the interface equipment 200 is approximately identical bit map data, while it is not coincident with the bit map data before the compression processing.

The interface equipment 200 appends halftone dot information and the like as a tag to the bit map data after the expansion processing and sends the same to the printer 300. The printer 300 outputs an image in accordance with the bit map data received from the interface equipment 200 and the appended tag information.

In the event that there is a need that the host controller 100 and the interface equipment 200 are constructed as an individual apparatus, for example, a case where the host controller 100 and the interface equipment 200 are separated from one another, and a case of a system in which the interface equipment 200 receives image data from a plurality of host controllers, there is provided such a construction that the host controller 100 carries out the compression processing and then transfers the same to the interface equipment 200 so that the interface equipment 200 performs the expansion processing. This construction makes it possible to reduce a data transfer time from the host controller 100 to the interface equipment 200 and thereby improving productivity of print.

Application of the compression processing as mentioned above may reduce an amount of data and contributes to reduction of a memory capacity and speeding up of a communication speed. However, in application of the compression processing, in the event that there is performed the non-reversible compression so that edge portions of characters and line drawings remain clear, or alternatively even if the reversible compression is concerned, in the event that there is performed the compression processing in which up to the high frequency component of an image is substantially completely saved, the compression rate is low, and accordingly, it is difficult to expect a great reduction of data amount by the compression processing. To the contrary, if it is intended to enhance the compression ratio, it is obliged to adopt the non-reversible compression and high frequency information is greatly reduced. Accordingly, a deterioration of the image quality is inconspicuous since the high frequency component is less wherein the continuous tone image such as photograph is concerned. However, a deterioration of edge portions of characters and line drawings is conspicuous, and thus the image quality is greatly deteriorated in its entirety.

### SUMMARY OF THE INVENTION

In view of the foregoing, it is an object of the present invention to provide an image compression apparatus capable of applying to an image consisting of bit map data compression processing in which a balance between enhancement of compression rate and maintenance of image quality is established in high level, and an image compression program storage medium storing an image compression program.

To achieve the above-mentioned objects, the present invention provides an image compression apparatus that compresses an original image consisting of bit map data after rasterizing, the image compression apparatus comprising:

an area dividing section that divides in an area the original image into an edge image consisting of an assembly of pixels each having a pixel value that is sharply varied as compared with peripheral pixels and a smooth image excepting the edge image from the original image, in accordance with a predetermined evaluation reference;

an edge image compression section that applies compression processing to the edge image obtained in the area dividing section; and

a smooth image compression section that applies compression processing to the smooth image obtained in the area dividing section.

According to the image compression apparatus of the present invention, the original image is divided in area into the edge image and the smooth image so that the edge image and the smooth image are subjected to the associated compression processing, respectively. For example, with respect to the edge image, it is subjected to the compression processing to express an edge portion to be clear, and with respect to the smooth image, it is subjected to the compression processing that is high in compression rate. This feature makes it possible to improve the compression rate while suppressing a deterioration of image quality to the minimum.

In the image compression apparatus according to the present invention as mentioned above, it is acceptable that the image compression apparatus further comprises a size reduction section that reduces the size of the smooth image obtained in the area dividing section and transfers the smooth image reduced in size to the smooth image compression section, and the smooth image compression section applies compression processing to the smooth image reduced in size, which is received from the size reduction section.

The continuous tone image such as photograph, which occupies a main part of the smooth image, is originally an image of resolution of, for example, 350 dpi (dot per inch). On the other hand, in order to express the edge portion to be clear characters and line drawings need higher resolution. According to the recent printer (cf. the printer 300), resolution of 600 dpi-1200 dpi is concerned. In case of the printing use, the specification such as 1200 dpi-2400 dpi is concerned. Accordingly, in the creation of the bit map data by the rasterizing, a continuous tone image is subjected to processing in which resolution is raised (the size is enlarged) to, for example, 1200 dpi to meet the resolution of the printer, and the continuous tone image raised in resolution is combined with images such as characters and line drawings to perform the rasterizing processing. Accordingly, the continuous tone image essentially needs no resolution of bit map data, and the smooth image including the continuous tone image is reduced in size and the smooth image reduced in size is subjected to the image processing. This feature makes it possible to prevent deterioration of image quality and improve the compression ratio.

In the image compression apparatus according to the present invention as mentioned above, it is acceptable that the edge image compression section applies reversal compression processing to the edge image.

In the image compression apparatus according to the present invention as mentioned above, it is acceptable that the smooth image compression section applies non-reversal compression processing to the smooth image.

In the image compression apparatus according to the present invention as mentioned above, it is acceptable that the predetermined evaluation reference evaluates as to whether a plurality of comparison pixels surrounding a noticed pixel includes a pixel having a pixel value having a difference exceeding a predetermined threshold as compared with a pixel value of the noticed pixel, and the area dividing section divides the noticed pixel into the edge image and the smooth image in accordance with the predetermined evaluation reference.

In the image compression apparatus according to the present invention as mentioned above, it is preferable that the area dividing section allots to pixels belonging to the edge image of the original image a mean value of pixel values of pixels excepting the pixels belonging to the edge image in a predetermined area including the pixels on the original image so as to create the smooth image.

Adoption of an area of 8 pixels×8 pixels as a predetermined area makes it possible to create a smooth image suitable for JPEG compression. Adoption of the mean value in a predetermined area makes it possible to create a smooth image removing the high frequency component.

In the image compression apparatus according to the present invention as mentioned above, it is acceptable that in a case where all pixels in the predetermined area are concerned with the pixels belonging to the edge image, the area dividing section allots to every pixel in the predetermined area a pixel value based on a mean value of pixel values of pixels excepting the pixels belonging to the edge image in an area adjacent to the predetermined area so as to create the smooth image.

In the image compression apparatus according to the present invention as mentioned above, it is acceptable that “a pixel value based on a mean value of pixel values of pixels excepting the pixels belonging to the edge image in an area adjacent to the predetermined area” establishes the mean value determined on an adjacent one area itself, as a pixel value of every pixel in the predetermined area. Or alternatively, it is acceptable that “a pixel value based on a mean value of pixel values of pixels excepting the pixels belonging to the edge image in an area adjacent to the predetermined area” establishes a pixel value determined by a linear interpolation of two mean values determined on two areas interposing the predetermined area, as a pixel value of every pixel in the predetermined area.

In the image compression apparatus according to the present invention as mentioned above, it is preferable that the area dividing section allots to pixels belonging to the edge image of the original image pixel values determined by a linear interpolation from pixel value of a plurality of pixels excepting the pixels belonging to the edge image, interposing the pixels on the original image, so that the smooth image is created.

Adoption of the linear interpolation also makes it possible to create the smooth image removing the high frequency component.

To achieve the above-mentioned objects, the present invention provides an image compression program storage medium storing an image compression program which causes an information processing apparatus to operate as an image compression apparatus that compresses an original image consisting of bit map data after rasterizing, when the image compression program is executed in the information processing apparatus, the image compression apparatus comprising:

an area dividing section that divides in an area the original image into an edge image consisting of an assembly of pixels each having a pixel value that is sharply varied as compared with peripheral pixels and a smooth image excepting the edge image from the original image, in accordance with a predetermined evaluation reference;

an edge image compression section that applies compression processing to the edge image obtained in the area dividing section; and

a smooth image compression section that applies compression processing to the smooth image obtained in the area dividing section.

In the image compression program storage medium storing the image compression program according to the present invention as mentioned above, it is acceptable that the image compression apparatus further comprises a size reduction section that reduces the size of the smooth image obtained in the area dividing section and transfers the smooth image reduced in size to the smooth image compression section, and

the smooth image compression section applies compression processing to the smooth image reduced in size, which is received from the size reduction section.

In the image compression program storage medium storing the image compression program according to the present invention as mentioned above, it is acceptable that the edge image compression section applies reversal compression processing to the edge image.

In the image compression program storage medium storing the image compression program according to the present invention as mentioned above, it is acceptable that the smooth image compression section applies non-reversal compression processing to the smooth image.

In the image compression program storage medium storing the image compression program according to the present invention, it is acceptable that the predetermined evaluation reference evaluates as to whether a plurality of comparison pixels surrounding a noticed pixel includes a pixel having a pixel value having a difference exceeding a predetermined threshold as compared with a pixel value of the noticed pixel, and the area dividing section divides the noticed pixel into the edge image and the smooth image in accordance with the predetermined evaluation reference.

In the image compression program storage medium storing the image compression program according to the present invention as mentioned above, it is preferable that the area dividing section allots to pixels belonging to the edge image of the original image a mean value of pixel values of pixels excepting the pixels belonging to the edge image in a predetermined area including the pixels on the original image so as to create the smooth image.

In the image compression program storage medium storing the image compression program according to the present invention as mentioned above, it is preferable that wherein in a case where all pixels in the predetermined area are concerned with the pixels belonging to the edge image, the area dividing section allots to every pixel in the predetermined area a pixel value based on a mean value of pixel values of pixels excepting the pixels belonging to the edge image in an area adjacent to the predetermined area so as to create the smooth image.

In the image compression program storage medium storing the image compression program according to the present invention as mentioned above, it is acceptable that the area dividing section allots to pixels belonging to the edge image of the original image pixel values determined by a linear interpolation from pixel value of a plurality of pixels excepting the pixels belonging to the edge image, interposing the pixels on the original image, so that the smooth image is created.

### BRIEF DESCRIPTION OF THE DRAWINGS

FIG. 1 shows an example of a print system in which a data compression technology is applied.

FIG. 2 is a hardware structural view of the host controller.

FIG. 3 is a flowchart useful for understanding a series of processing to be executed by the host controller shown in FIG. 1 and FIG. 2.

FIG. 4 is a typical illustration of a rasterized image.

FIG. 5 is an explanatory view useful for understanding image creating processing for smoothing in the area dividing section.

FIG. 6 is a typical illustration showing, by way of example, a rasterized image to be inputted to the area dividing section in FIG. 3.

FIG. 7 is a typical illustration showing, by way of example, an edge image that is created in the area dividing section in FIG. 3.

FIG. 8 is a flowchart useful for understanding a series of processing to be executed in the interface equipment shown in FIG. 1.

### DETAILED DESCRIPTION OF PREFERRED EMBODIMENTS

Embodiments of the present invention will be described with reference to the accompanying drawings.

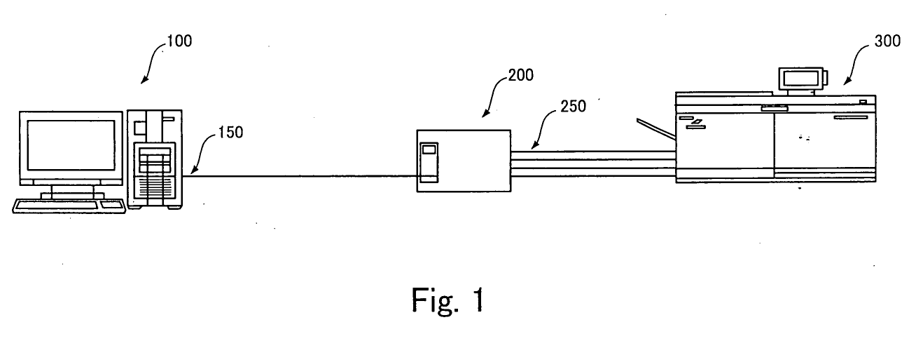

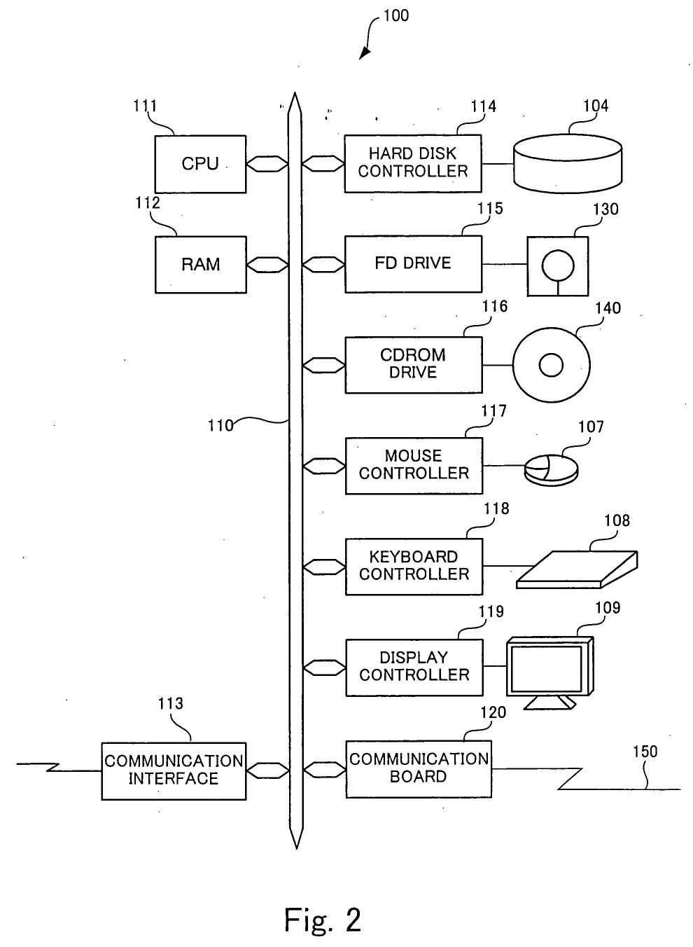

FIG. 1 shows an example of a print system in which a data compression technology is applied. FIG. 2 is a hardware structural view of the host controller.

A host controller 100 shown in FIG. 1 is constructed with the computer system shown in FIG. 2.

The host controller 100 comprises a CPU 111, a RAM 112, a communicating interface 113, a hard disk controller 114, a FD (flexible disk) drive 115, a CD-ROM drive 116, a mouse controller 117, a keyboard controller 118, a display controller 119, and a communicating board 120. These various types of elements are connected via a bus 110 to one another.

The hard disk controller 114 controls an access of a hard disk 104 that is incorporated into the host controller 100. The FD drive 115 and the CD-ROM drive 116 control an access of a flexible disk FD 130 and a CD-ROM 140, which are detachably mounted on the host controller 100, respectively. The mouse controller 117 and the keyboard controller 118 detect operations of a mouse 107 and a keyboard 108, which are provided on the host controller 100, respectively, and transmit the detected information to the CPU 111. The display controller 119 causes an image to be displayed on a display screen of an image display 109 provided on the host controller 100 in accordance with an instruction of the CPU 111.

The communicating board 120 performs a communication based on the general-purpose interface protocol such as SCSI. The communicating board 120 transfers the image data after the compression via a general-purpose interface cable 150 to the interface equipment 200 (cf. FIG. 1).

The communicating interface 113 performs the general-purpose such as Internet, so that the host controller 100 can take in image data via the communicating interface 113.

The program stored in the hard disk 104 is read on the RAM 112 and is developed for execution by the CPU 111. In the CPU 111, the program developed on the RAM 112 is read and executed.

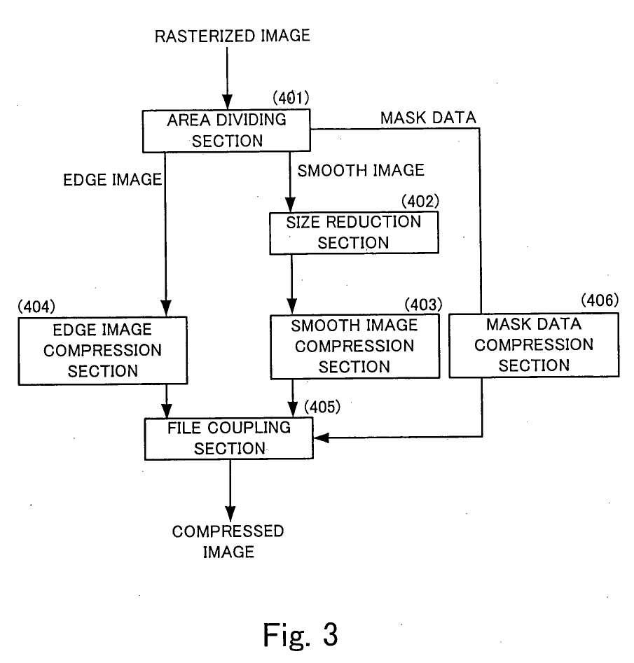

FIG. 3 is a flowchart useful for understanding a series of processing to be executed by the host controller shown in FIG. 1 and FIG. 2.

An image compression program related to an embodiment of the present invention is a program of performing processing shown in FIG. 3 in the host controller 100 shown in FIG. 1 and FIG. 2. An image compression apparatus as an embodiment of the present invention is a composite of the image compression program and the host controller 100 shown in FIG. 1 and FIG. 2, which executes the image compression program.

Here, a rasterized image, which is represented in form of bit map data by rasterizing, is divided by an area dividing section 401 into an edge image and a smooth image on an area basis.

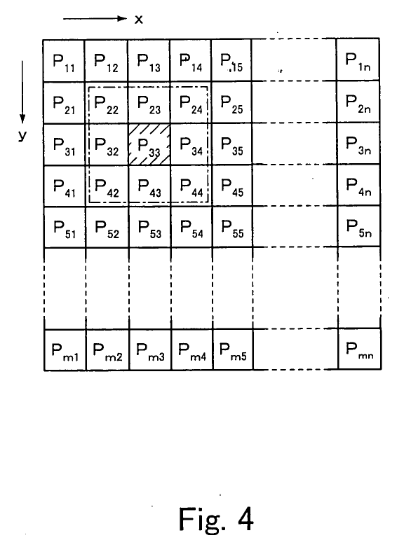

FIG. 4 is a typical illustration of a rasterized image.

The rasterized image consists of a plurality of pixels Pᵢⱼ (i=1, 2, . . . , m, j=1, 2, . . . , n), which is arranged on a two-dimensional basis.

Here, the pixels and the associated pixel values are not distinguished from one another, and the same symbol marks Pᵢⱼ are used for those elements. Here, the following evaluation base is adopted to distribute the pixels Pᵢⱼ between the edge image and the smooth image. Here, there will be explained a case where a pixel P₃₃ is typically selected as the noticed pixel, and the pixel P₃₃ is distributed between the edge image and the smooth image.

When the pixel P₃₃ is evaluated, there are determined difference values between the pixel value of the pixel P₃₃ and the every pixel values of a plurality of comparative pixels P₂₂, P₂₃, P₂₄, P₃₂, P₃₄, P₄₂, P₄₃, and P₄₄ of the area circled with the dashed line in FIG. 4, which surround the pixel P₃₃. That is, there are determined (P₃₃-P₂₂), (P₃₃-P₂₃), (P₃₃-P₂₄), (P₃₃-P₃₂), (P₃₃-P₃₄), (P₃₃-P₄₂), (P₃₃-P₄₃), and (P₃₃-P₄₄). And it is determined whether there is a pixel wherein the absolute value of the difference value exceeds a predetermined threshold (when the pixel value Pᵢⱼ has 0 to 255, for example, the threshold is 20). In the event that of the comparative pixels P₂₂, P₂₃, P₂₄, P₃₂, P₃₄, P₄₂, P₄₃, and P₄₄, there is at least one having the pixel value exceeding the threshold, it is decided that the noticed pixel P₃₃ is a pixel included in the edge image.

The area dividing section 401 in FIG. 3 performs processing that every one of the pixels Pᵢⱼ (i=1, 2, . . . , m, j=1, 2, . . . , n), which constitute the rasterized image shown in FIG. 4, is established as the noticed pixel, so that the rasterized image fed to the area dividing section 401 is divided into the edge image and the smooth image. According to the present embodiment, with respect to the edge image, the pixel, which belongs to the edge image, adopts the pixel value of the associated pixel, and the pixel, which belongs to the smooth image, adopts the pixel value “0”, so that the edge image is created. Further, according to the present embodiment, with respect to the smooth image, the pixel, which belongs to the smooth image, adopts the pixel value of the associated pixel, and the pixel, which belongs to the edge image, adopts the mean value of the pixel value of the pixels within the area of 8 pixels×8 pixels around the pixel, excepting the pixel value of the pixel that belongs to the edge image, so that the smooth image is created.

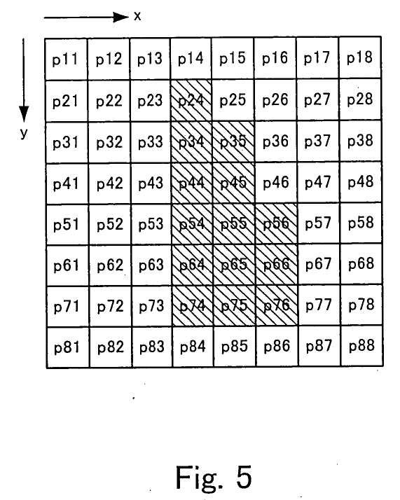

FIG. 5 is an explanatory view useful for understanding image creating processing for smoothing in the area dividing section.

FIG. 5 shows an area of 8 pixels×8 pixels, which is one cut out from the original image consisting of a large number of pixels of m-pixels x n-pixels shown in FIG. 4.

Here, it is assumed that 15 pixels, which are hatched as shown in FIG. 5, that is, all the pixels of p24, p34, p35, p44, p45, p54, p55, p56, p64, p65, p66, p74, p75, p76, and p86, are decided as pixels belonging to the edge image in accordance with the above-mentioned decision scheme. In this case, with respect to those 15 pixels, of 64 pixels in the area of 8 pixels×8 pixels, there is determined the mean value of the pixel values of 49 pixels that belong to the smooth image, excepting 15 pixels which are decided as the pixels that belong to the edge image, and the mean value thus determined is adopted as the pixel values for 15 pixels which are decided as the pixels that belong to the edge image, so that the smooth image is created on the area of 8 pixels×8 pixels.

The above-mentioned processing is performed for every area where the whole pixels shown in FIG. 4 is sequentially divided into the area of 8 pixels×8 pixels, so that the smooth image is created on the original image in its entirety.

When it is decided that all of the pixels in the area of 8 pixels×8 pixels shown in FIG. 5 are the pixels that belong to the edge image, there are determined mean values of the pixel values of the pixels, excepting the pixels which are decided as ones belonging to the edge image, on two areas each consisting of 8 pixels×8 pixels, which are adjacent to right and left of the area of 8 pixels×8 pixels shown in FIG. 5, and the linear interpolation based on the mean values of the right and left two areas, that is, (the mean value of the left area+the mean value of the right area)/2, is used to determine the pixel values of 64 pixels in the area of 8 pixels×8 pixels shown in FIG. 5 in its entirety, so that the pixel values thus determined are assigned to the 64 pixels.

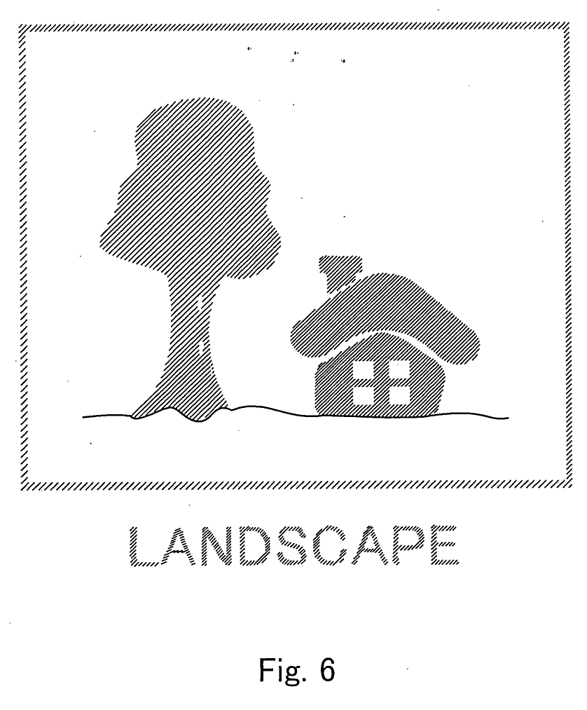

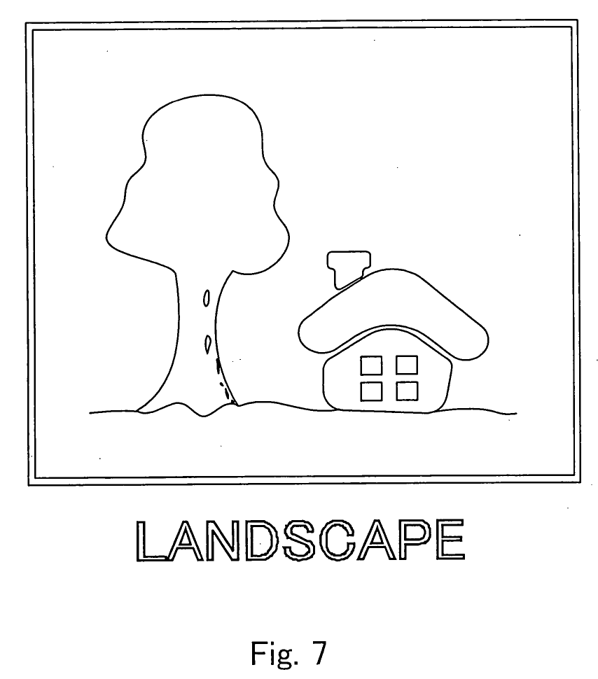

FIG. 6 is a typical illustration showing, by way of example, a rasterized image to be inputted to the area dividing section 401 in FIG. 3. FIG. 7 is a typical illustration showing, by way of example, an edge image that is created in the area dividing section 401 in FIG. 3.

As seen from FIG. 7, the edge image is an image including much high frequency components in which of the rasterized image shown in FIG. 6, only the portion that is extremely varied in the pixel value is extracted. Incidentally, while the smooth image is omitted in illustration, the smooth image is formed in such a manner that an area corresponding to the edge image shown in FIG. 7 from the rasterized image shown in FIG. 6 is filled with the above-mentioned mean value, and the high frequency component is suppressed.

The edge image and the smooth image, which are obtained in the area dividing section 401, are synthesized into one image. According to the present embodiment, the area dividing section 401 creates mask data indicative of information as to whether pixels constituting the rasterized image belong to the edge image or the smooth image, which is to be referred to in the synthesis. The mask data has the same bit number as the pixel number of the rasterized image. The area dividing section 401 establishes “1” for a bit associated with the mask data where the pixels constituting the rasterized image belong to the edge image, and establishes “0” for a bit associated with the mask data where the pixels constituting the rasterized image belong to the smooth image. According to the present embodiment, when the rasterized image is divided into the edge image and the smooth image, the above-mentioned binary mask data. The thus created mask data is transmitted to the interface equipment 200 shown in FIG. 1 together with the edge image and the smooth image, in the manner that will be described later.

With respect to the smooth image of the edge image and the smooth image, which are created by the area dividing section 401 shown in FIG. 3, a size reduction section 402 applies a size reduction processing to the smooth image.

According to the present embodiment, the rasterized image is concerned with the bit map data having resolution of 1200 dpi, and accordingly, the smooth image obtained in the area dividing section 401 also has resolution of 1200 dpi. Thus, the size reduction section 402 creates the smooth image of resolution 600 dpi in such a way that the pixels of the smooth image having the resolution of 1200 dpi are thinned every other pixel in both direction of x and y. In other words, assuming that the typical illustration shown in FIG. 4 is concerned with the typical illustration of the smooth image, the size reduction section 402 creates the smooth image of resolution 600 dpi consisting of every other pixels P₁₁, P₁₃, P₁₅, . . . , P₃₁, P₃₃, P₃₅, . . . only.

The smooth image, which is subjected to the size reduction processing by the size reduction section 402 shown in FIG. 3, is fed to a smooth image compression section 403 to perform an image compression processing. The smooth image compression section 403 applies JPEG compression processing, which is one of the non-reversible compression, to the entered smooth image. The JPEG compression is well known, and the compression processing method is not essential matter of present invention. Thus, further explanation for the compression processing of the smooth image compression section 403 will be omitted.

On the other hand, of the edge image and the smooth image, which are created in the area dividing section 401, the edge image is fed to an edge image compression section 404 to applies the compression processing to the edge image. The edge image compression section 404 applies the run length compression processing, which is one type of the reversible compression processing. The run length compression processing is also well known, and thus the explanation will be omitted.

Further, according to the present embodiment, the mask data, which is created in the area dividing section 401, is fed to a mask data compression section 406 to apply the run length compression processing.

There are fed to a file coupling section 405 the smooth compression image that is subjected to the JPEG compression processing by the smooth image compression section 403, the edge compression image that is subjected to the run length compression processing by the edge image compression section 404, and the mask data that is subjected to the run length compression processing by the mask data compression section 406. The file coupling section 405 couples the smooth compression image subjected to the JPEG compression processing by the smooth image compression section 403, the edge compression image subjected to the run length compression processing by the edge image compression section 404, and the mask data subjected to the run length compression processing by the mask data compression section 406 to one file, so that the compressed image is finally created.

The compressed image is transmitted from the host controller 100 shown in FIG. 1 via the general-purpose interface cable 150 to the interface equipment 200.

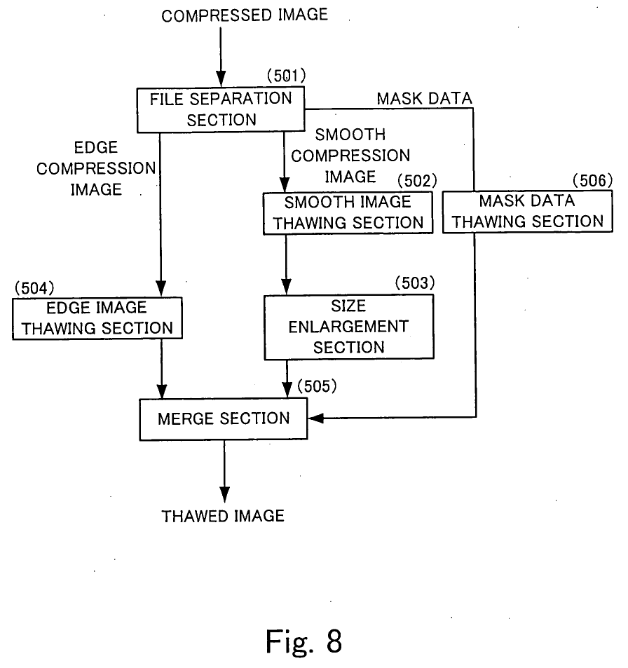

FIG. 8 is a flowchart useful for understanding a series of processing to be executed in the interface equipment shown in FIG. 1.

Upon receipt of the compressed image thus created in the host controller 100, the interface equipment 200 shown in FIG. 1 divides the compressed image into the smooth compressed image, the edge compressed image and the mask data, and feeds the smooth compressed image, the edge compressed image, and the mask data to a smooth image thawing section 502, an edge image thawing section 504, and a mask data thawing section 506, respectively.

The smooth compressed image, which is fed to the smooth image thawing section 502, is subjected to JPEG thawing processing, which is reverse processing of JPEG compression to be carried out by the smooth image compression section 403 in FIG. 3. The smooth image subjected to the JPEG thawing processing is fed to a size enlargement section 503 to perform reverse processing of the size reduction processing to be performed by the size reduction section 402 in FIG. 3, that is, processing of enlarging the smooth image of 600 pdi in size to the smooth image of 1200 pdi in size. According to the present embodiment, the size of the smooth image is enlarged in such a manner that the pixels of copy of the pixel values of the adjacent pixels are inserted.

The edge compression image, which is fed to the edge image thawing section 504, is subjected to the reverse processing of the run length compression processing by the edge image compression section 404 in FIG. 3, by the edge image thawing section 504, so that the same edge image before the compression processing is created.

Further, the mask data thawing section 506 applies to the entered mask data the reverse processing of the run length compression processing by the mask data compression section 406 shown in FIG. 3, so that the same mask data as one before the compression processing is created.

Fed to a merge section 505 are the edge image that is subjected to the thawing processing by the edge image thawing section 504, the smooth image that is subjected to the thawing processing by the smooth image thawing section 502 and is subjected to the size enlargement processing by the size enlargement section 503, and the mask data that is subjected to the thawing processing by the mask data thawing section 506. The merge section 505 selects for each pixel the pixel of the edge image or the pixel of the smooth image in accordance with the mask data, and creates the thawed image associated with the original rasterized image. The thawed image is free from deterioration of image quality, since the edge portion adopts the run length compression processing that is a type of reversible compression processing. Portion other than the edge portion adopts JPEG compression that is a type of reversible compression. Portion other than the edge portion is a little essentially in high frequency component, and thus even an increment of the compression rate is hard to bring about a conspicuous deterioration of image quality. In other words, according to the present embodiment, it is possible to implement a high compression rate, with a suppression of a deterioration of image quality, and thereby implementing a high speed transmission of image data from the host controller 100 shown in FIG. 1 to the interface equipment 200.

According to the present embodiment, the smooth image compression section 403 shown in FIG. 3 adopts the JPEG compression. It is noted, however, that this is only an example, and any one is acceptable, as the compression processing, which is suitable for compression of the smooth image.

In a similar fashion, according to the present embodiment, the edge image compression section 404 shown in FIG. 3 adopts the run length compression processing. It is noted, however, that this is only an example, and any one is acceptable, as the compression processing, which is suitable for compression processing of the edge image.

Further, with respect to the mask data, according to the present embodiment, the run length compression processing is applied. It is noted, however, that any one is acceptable, as the compression processing, which is concerned with the reversible compression processing, or alternatively, it is acceptable to omit the compression processing.

Further, according to the present embodiment, the smooth image formed by the area dividing section 401 in FIG. 3 fills up the ineffective pixels on the smooth image, which corresponds to the effective image of the edge image, with the mean value of 8 pixels×8 pixels. This filling up scheme is made in view of the JPEG compression processing in the smooth image compression section 403. A filling up scheme is not restricted to the filling up scheme as mentioned above. When the compression processing in the smooth image compression section 403 is concerned with the run length compression, it is acceptable to copy the pixel values of the effective pixels on the smooth image, which are located before the ineffective pixels on the data stream. When the compression processing in the smooth image compression section 403 is concerned with the compression processing which is efficient in the pixel value 0, it is acceptable to fill up the ineffective pixels with the pixel value 0.

Now referring to FIG. 5 again, there will be explained another example of a smooth image creating processing in the area dividing section 401.

In a similar fashion to that of the above description, it is assumed that it is decided that the pixels hatched in FIG. 5 are the pixels belonging to the edge image. Also here, the same reference numbers are applied to the every pixel and the pixel value of the associated pixel.

Here, for every pixel hatched in FIG. 5, which belongs to the edge image of the original image, there is determined every pixel value of the associated pixel belonging to the edge image hatched in FIG. 5 in accordance with the linear interpolation from pixel values of two pixels excepting pixels belonging to the edge image, between which the pixel is put, on the original image, and the determined every pixel value is filled up for the associated pixel belonging to the edge image. Specifically, the following linear interpolation operation is carried out to determine the pixel value of every pixel of the edge image.
With respect to the pixel p24, p24=(p23+p25)/2
With respect to the pixel p34, p34=p33+(p33−p36)/3
With respect to the pixel p35, p35=p33+(p33−p36)·2/3
. . .
With respect to the pixel p54, p54=p53+(p53−p57)/4
With respect to the pixel p55, p53=p53+(p53−p57)·2/4
With respect to the pixel p56, p53=p53+(p53−p57)·3/4
. . .

The determined pixel value is filled up to the associated pixel.

According to this example, the linear interpolation is carried out in the x-direction as shown in FIG. 5. It is acceptable, however, that the linear interpolation is carried out in the y-direction. In this case, the following linear interpolation operation is carried out.
With respect to the pixel p24, p24=p14+(p14−p84)/7
With respect to the pixel p25, p25=p14+(p14−p84)−2/7
. . .

As to whether the linear interpolation is carried out in the x-direction or the y-direction, it is determined in accordance with a sequence of pixels to be read from a memory in a case where the linear interpolation is carried out in such a manner that the image data is stored in the memory and the pixels are sequentially read from the memory one by one. That is, when the pixels are sequentially read in the x-direction as shown in FIG. 5, the linear interpolation in the x-direction is suitable. When the pixels are sequentially read in the y-direction as shown in FIG. 5, the linear interpolation in the y-direction is suitable.

According to the present embodiment, the resolution of the rasterized image is 1200 dpi, and the size reduction section 402 reduces the smooth image of 1200 dpi to the smooth image of 600 dpi. However, the reduction size is not restricted to 600 dpi. It is acceptable that the size reduction section 402 further reduces the smooth image in size in view of the magnitude of the threshold wherein the area dividing section 401 divides the image into the edge image and the smooth image, and tolerance of deterioration of image quality for the smooth image. Further it is noted that the resolution of the rasterized image is also not restricted to 1200 dpi.

Further, according to the present embodiment, the area dividing section 401 creates the mask data separately from the edge image and the smooth image. However, when the reversible compression processing is carried for at least one of the edge image and the smooth image (according to the present embodiment, the reversible compression processing is carried for the edge image), it is acceptable to perform the image synthesis under such a rule that the ineffective pixels of the image, which is to be subjected to the reversible compression processing, that is, the edge image according to the present embodiment, are filled up with the specific value, and the pixels of the specific value are concerned with the ineffective pixels on the edge image and the smooth image is concerned with the effective pixels.

Furthermore, according to the present embodiment, the area dividing section 401 of FIG. 3 compares the pixel value of the noticed pixel with the pixel values of 8 pixels around the noticed pixel to decide whether the noticed pixel is concerned with the pixel belonging to the edge image or the pixel belonging to the smooth image. However, it is acceptable that the pixel value of the noticed pixel is compared with the pixel values of the more number of pixels around the noticed pixel.

As mentioned above, according to the present invention, it is possible to provide an image compression apparatus capable of applying to an image consisting of bit map data compression processing in which a balance between enhancement of compression rate and maintenance of image quality is established in high level, and an image compression program storage medium storing an image compression program.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An image compression apparatus that compresses an original image consisting of bit map data after rasterizing, the image compression apparatus comprising:
an area dividing section that divides in an area the original image into an edge image consisting of an assembly of pixels each having a pixel value that is sharply varied as compared with peripheral pixels and a smooth image excepting the edge image from the original image, in accordance with a predetermined evaluation reference;
an edge image compression section that applies compression processing to the edge image obtained in the area dividing section; and
a smooth image compression section that applies compression processing to the smooth image obtained in the area dividing section.

2. An image compression apparatus according to claim 1, wherein the image compression apparatus further comprises a size reduction section that reduces the size of the smooth image obtained in the area dividing section and transfers the smooth image reduced in size to the smooth image compression section, and
the smooth image compression section applies compression processing to the smooth image reduced in size, which is received from the size reduction section.

3. An image compression apparatus according to claim 1, wherein the edge image compression section applies reversal compression processing to the edge image.

4. An image compression apparatus according to claim 1, wherein the smooth image compression section applies non-reversal compression processing to the smooth image.

5. An image compression apparatus according to claim 2, wherein the smooth image compression section applies non-reversal compression processing to the smooth image.

6. An image compression apparatus according to claim 1, wherein the predetermined evaluation reference evaluates as to whether a plurality of comparison pixels surrounding a noticed pixel includes a pixel having a pixel value having a difference exceeding a predetermined threshold as compared with a pixel value of the noticed pixel, and the area dividing section divides the noticed pixel into the edge image and the smooth image in accordance with the predetermined evaluation reference.

7. An image compression apparatus according to claim 1, wherein the area dividing section allots to pixels belonging to the edge image of the original image a mean value of pixel values of pixels excepting the pixels belonging to the edge image in a predetermined area including the pixels on the original image so as to create the smooth image.

8. An image compression apparatus according to claim 7, wherein in a case where all pixels in the predetermined area are concerned with the pixels belonging to the edge image, the area dividing section allots to every pixel in the predetermined area a pixel value based on a mean value of pixel values of pixels excepting the pixels belonging to the edge image in an area adjacent to the predetermined area so as to create the smooth image.

9. An image compression apparatus according to claim 1, wherein the area dividing section allots to pixels belonging to the edge image of the original image pixel values determined by a linear interpolation from pixel value of a plurality of pixels excepting the pixels belonging to the edge image, interposing the pixels on the original image, so that the smooth image is created.

10. An image compression program storage medium storing an image compression program which causes an information processing apparatus to operate as an image compression apparatus that compresses an original image consisting of bit map data after rasterizing, when the image compression program is executed in the information processing apparatus, the image compression apparatus comprising:
an area dividing section that divides in an area the original image into an edge image consisting of an assembly of pixels each having a pixel value that is sharply varied as compared with peripheral pixels and a smooth image excepting the edge image from the original image, in accordance with a predetermined evaluation reference;
an edge image compression section that applies compression processing to the edge image obtained in the area dividing section; and
a smooth image compression section that applies compression processing to the smooth image obtained in the area dividing section.

11. An image compression program storage medium storing the image compression program according to claim 10, wherein the image compression apparatus further comprises a size reduction section that reduces the size of the smooth image obtained in the area dividing section and transfers the smooth image reduced in size to the smooth image compression section, and
the smooth image compression section applies compression processing to the smooth image reduced in size, which is received from the size reduction section.

12. An image compression program storage medium storing the image compression program according to claim 10, wherein the edge image compression section applies reversal compression processing to the edge image.

13. An image compression program storage medium storing the image compression program according to claim 10, wherein the smooth image compression section applies non-reversal compression processing to the smooth image.

14. An image compression program storage medium storing the image compression program according to claim 11, wherein the smooth image compression section applies non-reversal compression processing to the smooth image.

15. An image compression program storage medium storing the image compression program according to claim 10, wherein the predetermined evaluation reference evaluates as to whether a plurality of comparison pixels surrounding a noticed pixel includes a pixel having a pixel value having a difference exceeding a predetermined threshold as compared with a pixel value of the noticed pixel, and the area dividing section divides the noticed pixel into the edge image and the smooth image in accordance with the predetermined evaluation reference.

16. An image compression program storage medium storing the image compression program according to claim 10, wherein the area dividing section allots to pixels belonging to the edge image of the original image a mean value of pixel values of pixels excepting the pixels belonging to the edge image in a predetermined area including the pixels on the original image so as to create the smooth image.

17. An image compression program storage medium storing the image compression program according to claim 16, wherein in a case where all pixels in the predetermined area are concerned with the pixels belonging to the edge image, the area dividing section allots to every pixel in the predetermined area a pixel value based on a mean value of pixel values of pixels excepting the pixels belonging to the edge image in an area adjacent to the predetermined area so as to create the smooth image.

18. An image compression program storage medium storing the image compression program according to claim 10, wherein the area dividing section allots to pixels belonging to the edge image of the original image pixel values determined by a linear interpolation from pixel value of a plurality of pixels excepting the pixels belonging to the edge image, interposing the pixels on the original image, so that the smooth image is created.
